(19) United States
(12) Patent Application Publication
(10) Pub. No.: US 2024/0092151 A1
(43) Pub. Date: Mar. 21, 2024

(54) AUTOMOBILE VISOR SUN BLOCKER SYSTEM

(71) Applicant: Bassem Alhalabi, Boca Raton, FL (US)

(72) Inventor: Bassem Alhalabi, Boca Raton, FL (US)

(21) Appl. No.: 17/947,137

(22) Filed: Sep. 18, 2022

(51) Int. Cl. B60J 3/02

(52) U.S. Cl. CPC B60J 3/0208

(57) ABSTRACT

The idea of this invention is to increase the visibility of the road and traffic signals for drivers as they are driving facing the sun directly. The main concept is to block the sun rays completely from the road view without darkening the total view through the visor shades.

The invention still uses a light shaded panel attached to the visor to reduce the glare from the entire view, but in addition, it eliminates completely sun rays going straight to the eyes. This elimination concept is achieved by creatively placing two dark blocking circles on the shade to stop the sun rays going directly to the eyes.

### BACKGROUND

### Technical Field

The present disclosure generally relates to an automobile visor sun blocker system.

### Description of the Related Art

Driving east in the morning at sunrise or west in the evening at sunset is quite a challenge as the sun shines straight horizontally into the driver's eyes. In many instances, the sun is even lower than the traffic lights on the street making it almost impossible for the driver to see the traffic lights if they are green or red or even seeing the road itself. Lowing the visor will help reduce some of the sun glare into the eyes, but still the sun is blinding the vision as it is lower that the traffic lights. In these cases, the drivers tend to lower the visor below the line of the traffic lights to block the sun, and then use only one eye looking from one side of the visor. In these situations, the total visibility of the road is severely compromised, and if there are a stalled car on the road mostly likely it will not be visible till last moment, and an accident could very much happen.

There are too many kinds of sunshades in the market to count, but they are of the same idea, which is a dark shaded panel attached to the visor to darken the entire view through the wind shield. When the sun is very low, however, it still shines straight into the eyes, making the road/traffic light view very blurry. Using much darker shades will reduce the sun glare, but it will also reduce the total visibility.

### SUMMARY

The concept of this invention is to ultimately and completely block the sun rays from the total view without compromising the whole view by making it too dark. So the invention still used a light shaded panel to reduce the glare in the total view, and then blinds the direct sun completely.

The way it works is inspired from the human nature of how the brain super imposes two views seen from the two eyes to create a more crisp and wider 3D total view. The two views seen by the two eyes are shifted apart from each other when you try to look using one eye at time. You can make an experiment by placing your pointer finger ahead of you at distance similar to the visor on your car and then look at your computer screen using one eye at a time. You will notice that your finger is blocking different part of the view for each eye. Now if you look at your computer screen with two eyes, you can see the whole view. Yes, you still see your finger super imposed on the screen view with a certain degree of transparency.

Let us say you are reading a page of text on your screen which is two feet away from your eyes. Now place your finger or any other object vertically, say a 1-inch-wide ruler, you will be able to continue to see and read the text without any interruption. If you try to read with one eye at a time, you see that the ruler is blocking different vertical strips of the text. With two eyes open at the same time and the brain lining up the two images together where each image is missing a different portion (vertical strips) of the text, the composed image looks complete with two narrow strips that are a bit faded.

Now, the focus here is to block the sun, which is the same area we need to block in the two views seen by the two eyes. Therefore, we use two vertical objects to block the exact same portion of the views, the direct sun rays. Since the sun is so far away from our eyes, the sun rays coming to the two eyes are near parallel, and two design concepts can be derived:

The two vertical blocking objects must be apart from each other the same distance as the human eyes, which is known as the pupillary distance.

The size of the blocking object can be just a bit larger than the size of the human pupils.

With the sun being round, the shape for the blocking object can also be round instead of a straight band like the ruler.

With these three design criteria, we can use two dark circles to block the sun being seen by the two eyes. With the images, each with a small circle of blocked or darkened portion in different places, the brain will super impose them and create a complete view.

From the anatomy of the human eyes, the centers of the two blocking circles should be the average of the pupillary distance which is 54-74 mm, so we use 64 mm. Now we should make the radius of circles large enough to cover the fall range of the pupillary distance, so we use this simple equation: (74−54)/2=10 mm. This means the center of the human eye among all adults could be a bit to the left or right within 10 mm. So, to cover the whole spanning area, the blocking circle diameter should be slightly over 10×2 mm. For a given embodiment, we choose the size of 25 mm, which is about an inch.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

FIG. 1 shows a front view of an automobile sun blocker system

FIG. 2 shows a diagram with regard to the sun blocking circles and their relative distances.

FIG. 3 shows a diagram with regard to how the automobile sun blocker system interacts with both of the driver's eyes.

FIG. 4 shows a diagram with regard to how the automobile sun blocker system interacts with the driver's left eye.

FIG. 5 shows a diagram with regard to how the automobile sun blocker system interacts with the driver's right eye.

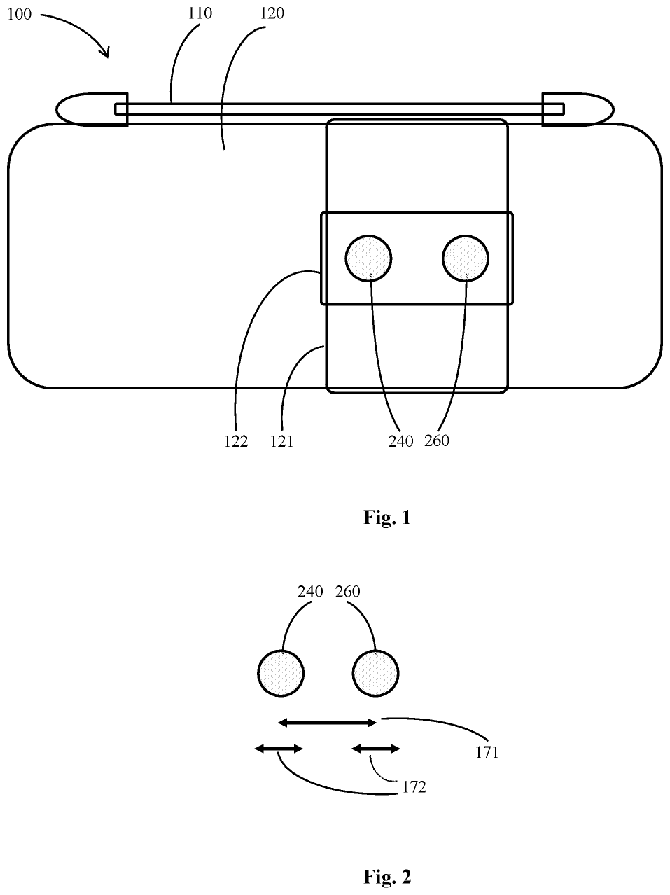

### DETAILED DESCRIPTION

### Overview

The automobile visor sun blocker system is composed of flat acrylic shade 120 which is about the size of visor. It has on the top a mechanism 110 which enables the driver to attach it to the visor. On that shade there is a horizontally sliding platform of clear acrylic 121, on which another clear acrylic platform 122 which slides vertically. On the vertically sliding platform 122, the two sun blocking circles 241 and 261 are mounted. With these two sliding platforms 121 and 122, the two sun blocking circles can be positioned anywhere on the entire shade 120.

The two sun blocking circles are basically a very dark shaded round stickers and thin pasted on the platform 122. They completely block the sun if you look straight into the sun through these two circles. As depicted in FIG. 2, the distance between the centers of the blocking circles 241 and 261 is identified as line 171, and it is 64 mm. The diameter of the blocking circles is identified ad line 172 and it is 25 mm.

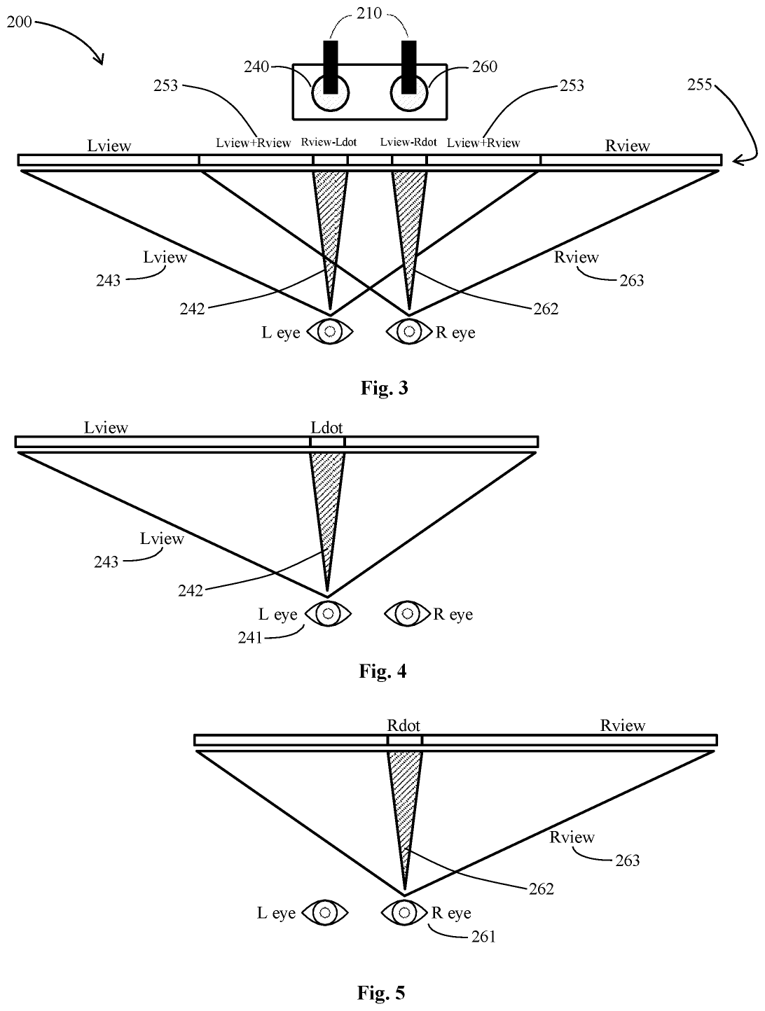

FIG. 3 shows the concepts of how the left eye 241 and the right eye 261 see two different views, the left view 243 and the right view 263. It also shows how the blocking circles 240 and 260 while they are blocking the sun rays 210, they also create a dark dot in the eye view, mainly a dark spot, Ldot 242, in the left view 243 and a dark spot, Rdot 262, in the right view 263. Then when the two eyes super impose the two views inside the brain and the total view 255 will be composed as follows:

FIG. 4 shows the view as seen by the left eye 241:

Lview 243, a view which extends to the left beyond the center point of the eye.

Due to the blocking circle 240, the left view 243 will be missing a dot, Ldot 242.

FIG. 5 shows the view as seen by the right eye 261:

Rview 263, a view which extends to the right beyond the center point of the eye.

Due to the blocking circle 260, the right view 263 will be missing a dot, Rdot 262.

Now if we super impose the two views Lview 243 and Rview 263, we notice that the missing dot, say Ldot 242 will be compensated for by the Rview 263. Similarly, the missing dot Rdot 262 will be compensated for by the Lview 243. Besides these two areas of Ldot and Rdot, a big portion of the Lview and Rview will also overlap creating a big area of Lview+Rview. The total view 255 will be concatenation of few segments as follows:

Lview∥Lview+Rview∥Rview−Ldot∥Lview+Rview∥Lview−Rdot∥Lview+Rview∥Rview

In short, the total view seen by the two eyes together will be wide and composed of the Lview and the Rview. The two blocking circles will completely block the sun from the view, but those two resulting dots will not look completely dark, as each of the two eyes compensates for the other.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments of the disclosure are also contemplated. There are also embodiments of the disclosure in which the components and/or operations are arranged and/or ordered differently than described and shown herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. An automotive sun blocking system with an attaching mechanism to attach to the visor on the driver's or the passenger's side, comprising of:
a. A flat panel of clear acrylic with a light gray color to provide some basic shading to reduce the sun glare while driving;
b. Two dark spots affixed on the panel in the center;
c. These two dark spots are 64 mm apart, center to center;
d. These two dark spots are 20 to 25 mm in diameter.

2. The two dark spots of claim 1, are composed of multiple layers of dark shaded film, so that the darkness of the spots could be adjusted from completely to partially blocking as desired by the driver.

3. In another embodiment, the two dark spots of claim 1 can be affixed on a mechanism of clear acrylic sliding platform, which sweeps horizontally and vertically all over the panel, to adjust the position of the dots on the panel.

4. The sweeping mechanism of claim 3 can be motorized so that the position of the two spots on the panel is adjusted automatically based the data coming from a sensor, which senses if the sun rays are vertical on the driver's windshield or with a certain angle.

5. In another embodiment, the two dark spots of claim 1 can be mounted on rotating discs with the spots positioned off the center, so that if the driver rotates the disks, the spots can be adjusted so that distance between the centers is matched with diver's pupillary distance.

6. In another embodiment, the two dark spots of claim 1 can be built as an integral part of the car windshield at the time of manufacturing.

7. In another embodiment, the two dark spots of claim 1 can be built as an integral part of a typical sunglasses, where the spots are placed a bit above the center of each eye.

8. The two dark spots of claim 7 could be permanently affixed on the sunglasses or made detachable so they can be adjusted and reattached to match the desired location.
